(19) United States
(12) Patent Application Publication
(10) Pub. No.: US 2008/0198918 A1
(43) Pub. Date: Aug. 21, 2008

(54) Compression and Decompression Using Corrections of Predicted Values

(75) Inventor: Renatus Josephus Van Der Vleuten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,975

(22) PCT Filed: May 10, 2006
(86) PCT No.: PCT/IB2006/051465

§ 371 Date: Nov. 20, 2007

(30) Foreign Application Priority Data
May 24, 2005 (EP) 05104403.0

(51) Int. Cl. H04B 1/66

(52) U.S. Cl. 375/240

(57) ABSTRACT

A decompression process is used that forms a decompressed data value by adding a correction value to a signal value prediction. During compression the required correction value is computed. The correction value is encoded in two parts, such as an absolute value and a sign. It is tested whether more than one valid possible decompressed data value can be obtained by adding the signal value prediction to all of a plurality of different possible correction values that are consistent with a first part. A second part of the correction information is included in the compressed data, for selecting among the more than one possible decompressed data values, conditional on a result of said testing. The second part is omitted in cases where there is no more than one valid possible decompressed data value. During decompression the prediction is determined and it is tested whether the second part is needed or not to determine an unambiguous signal value. The second part is read from the compressed data when it is needed to select an unambiguous signal value.

The invention relates to signal compression and decompression, of video signals for example.

WO 91/15926 describes signal compression techniques that use DPCM (Differential Pulse Code Modulation). DPCM makes use of predictions of signal values and encodes the actual signal values in terms of corrections to the predicted signal values. A simple prediction could be that a signal value for a particular pixel in an image will be the same as that for a neighboring pixel. In this case the pixel value for the particular pixel is encoded by the difference with respect to the signal value to that neighboring pixel.

When good predictions are used, less signal bandwidth will be needed on average to encode the signal values and/or less loss of information will occur during compression within a given bandwidth. The term “bandwidth”, as used herein is a measure of the memory space needed to store the compressed signal and/or the time needed to transmit the compressed signal. In one example, the corrections are non-uniformly quantized, using larger quantization steps (and therefore larger quantization errors) for larger sized corrections than for smaller size corrections. The quantization saves bandwidth and when large corrections occur infrequently little information is lost. In image compression, moreover, errors in the large correction lead to less perceptible artifacts. In another example, the corrections are clipped between a maximum and minimum correction with similar effect. In a further example variable length coding (e.g. Huffman coding) is used for the corrections, so that less bandwidth is used for small corrections at the expense of larger bandwidth for larger corrections that occur infrequently.

WO 91/15926 describes the Bostelmann compression wherein bandwidth can be reduced further by omitting the sign bit from all corrections in the compressed signal. This technique starts from corrections that are capable of representing the full range of possible corrections, that is, from plus the difference between the maximum and minimum valid signal value to minus that difference in two's complement representation. The difference between the maximum and minimum valid signal value is a power of two: 2ⁿ (n an integer, e.g. n=8), so that the corrections are in a range of 2ⁿ⁺¹ values.

The omission of the sign bit makes it ambiguous whether the correction is positive or negative. Two correction values, which are mutually apart by the difference between the maximum and minimum valid signal value, give rise to the same value when the sign bit is omitted. But only one of these correction values will lead to a correction value within the range of valid signal values. This makes it possible to remove the ambiguity during decompression.

However, this technique leads to a probability distribution of the sign-stripped corrections with peaks near very small corrections and very large corrections (which correspond to small negative corrections). This means first of all that complicated forms of variable length decoding or non-uniform quantization. Furthermore it means that the entropy of the probability distribution increases: the distribution is smeared. This has the effect that more bits will be needed to convey the same amount of information about the sign stripped correction when variable length coding is needed, or to provide non-uniform quantization with the same average quantization error.

Among others it is an object of the invention to reduce the amount of compressed information that is needed to represent signal values with at least a predetermined accuracy and/or to increase the accuracy achievable for a given compression rate.

Among others it is an object of the invention to reduce bandwidth needed for transmission or storage space needed for storage of compressed information that is needed to represent signal values with at least a predetermined accuracy and/or to increase the accuracy achievable for a given amount of storage space or bandwidth.

According to one aspect the invention provides for a compression apparatus according to Claim 1. During decompression decompressed data value is formed by adding a correction to a signal value prediction obtained from the compressed data (“adding” as used here is not limited to arithmetic addition, it covers arithmetic addition in a preferred embodiment, but it includes other ways of combining values, such as subtraction). During compression the correction is computed and first and second part of correction information are inserted into the compressed data. The first part of the correction information represents for example an absolute value of the correction (i.e. plus or minus the correction if the correction is positive or negative respectively). More generally the division of the correction information into parts is so that the first part of the correction information is consistent with more than one possible correction value.

Under selected conditions the second part of the correction information (for example the sign of the correction value) is omitted from the compressed data. This is done after testing whether no more than one of the more than one possible correction values, when added to the signal value prediction, lead to valid decompressed values, for example to decompressed values between a minimum and maximum value. The space in the compressed data for the second part of the correction information is used for another purpose if there is only one such possible correction value consistent with the first part of the correction information. If there are more valid possible values the second part of the correction information is included in the compressed data. In this way storage space or transmission bandwidth is saved if the compressed data is stored or transmitted. Also, of course the second part of the correction information may be omitted if only one correction is consistent with the first part of the correction information, e.g. if the first part represents an absolute value of zero.

Preferably the first part of the correction information is computed so that different possible correction values that are consistent with a same value of the first part have substantially the same probability of occurrence. Typically corrections with the same absolute value, but different sign, have the same probability of occurrence. Therefore in one embodiment different corrections with the same absolute value are represented by a same value of the first part of the correction information. In a further embodiment, the first part of the correction information is simply the absolute value.

Preferably the first part of the correction information is represented by a non-uniformly quantized value, preferably by quantizing with larger quantization gaps for larger correction values. In addition or alternatively, the first part may be encoded using variable length encoding, so that less likely correction values are encoded with more bits than more likely correction values. When the probability distribution of the first part has the same uneven probability distribution as the original correction values this can be done with maximum compression efficiency.

The space created by omission of the correction values may be used for different purposes. In one embodiment it is used simply to reduce the bandwidth needed for the compressed signal. In another embodiment it is used to stored information to refine the first part of the correction information, e.g. to indicate in which of different halves of the quantization steps the correction value lies. Preferably this is applied selectively to those correction values for which the second part of the correction information is omitted. This improves the compression accuracy more than the refinement of randomly selected corrections because these corrections without second part have more than normal probability of being corrections that have large quantization errors.

During decompression the first part of the correction value is read and it is tested whether there is more than one possible correction that would lead to a valid decompressed signal. If this is not the case different information is read from the space for the second part of the correction value. Thus, decoding avoids errors due to the omission of the second part of the correction information.

These and other aspects and objects of the invention will be described using non-limitative embodiments of the invention, by reference to the following figures.

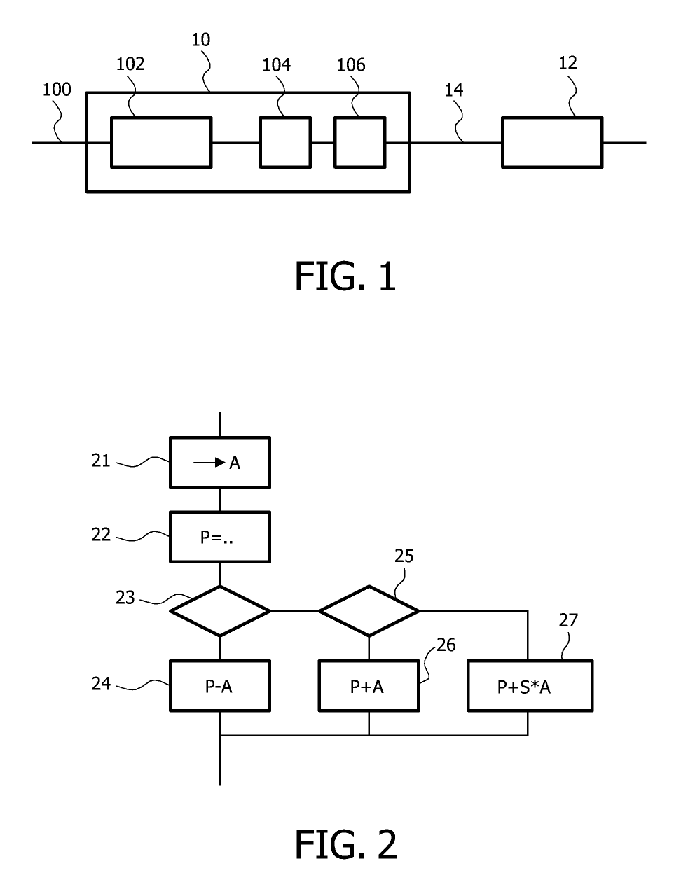

FIG. 1 shows a compression-decompression system;

FIG. 2 shows a flow-chart of a decompression process;

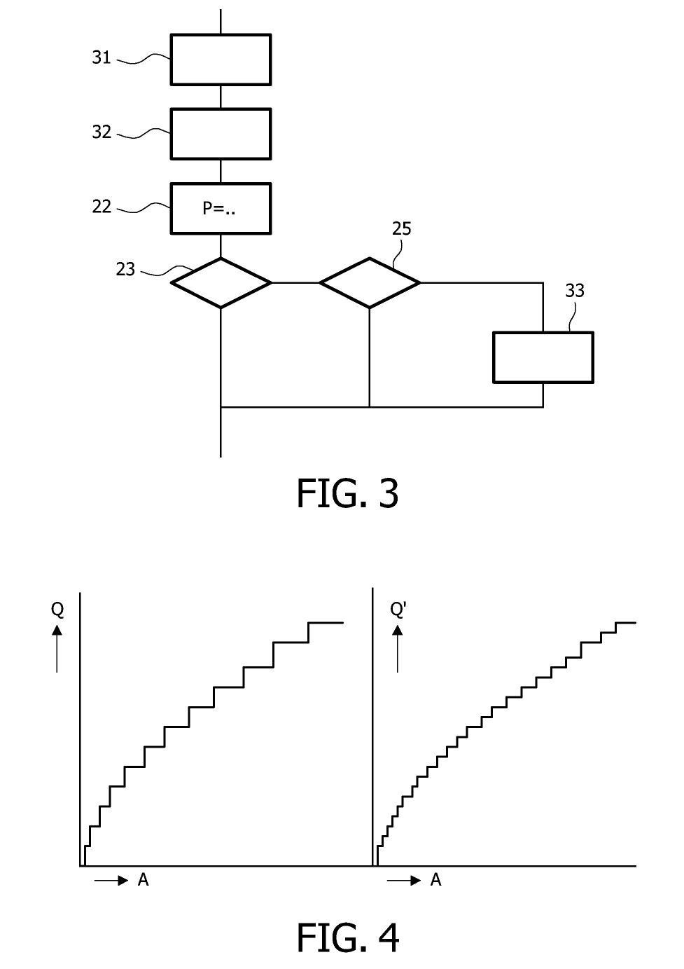

FIG. 3 shows a flow-chart of a compression process;

FIG. 4 shows quantization steps;

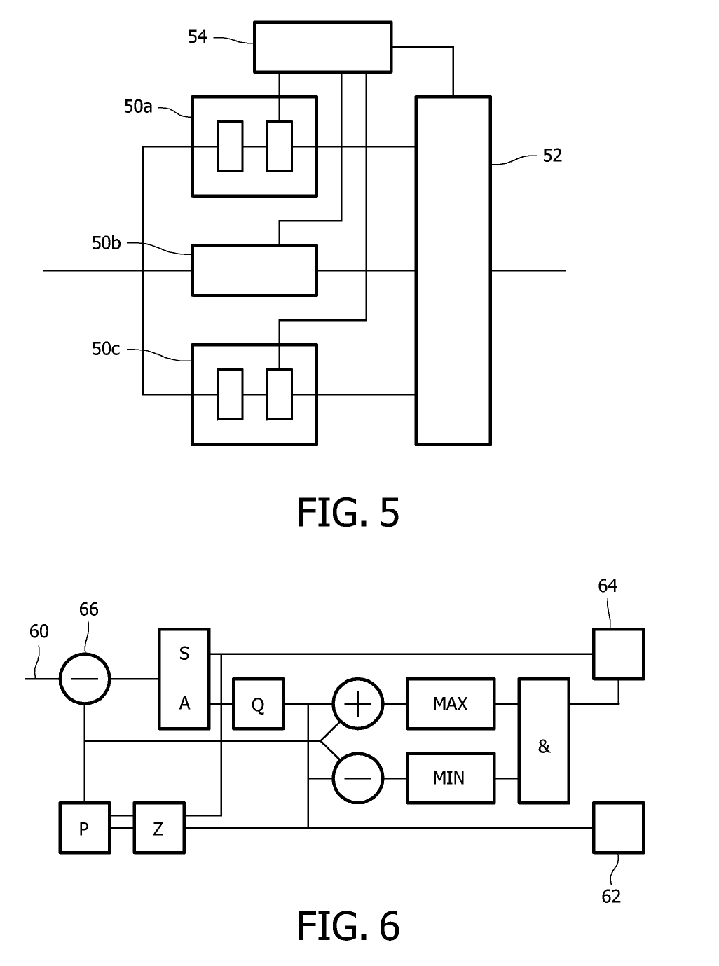

FIG. 5 shows a compression apparatus;

FIG. 6 shows a compression apparatus;

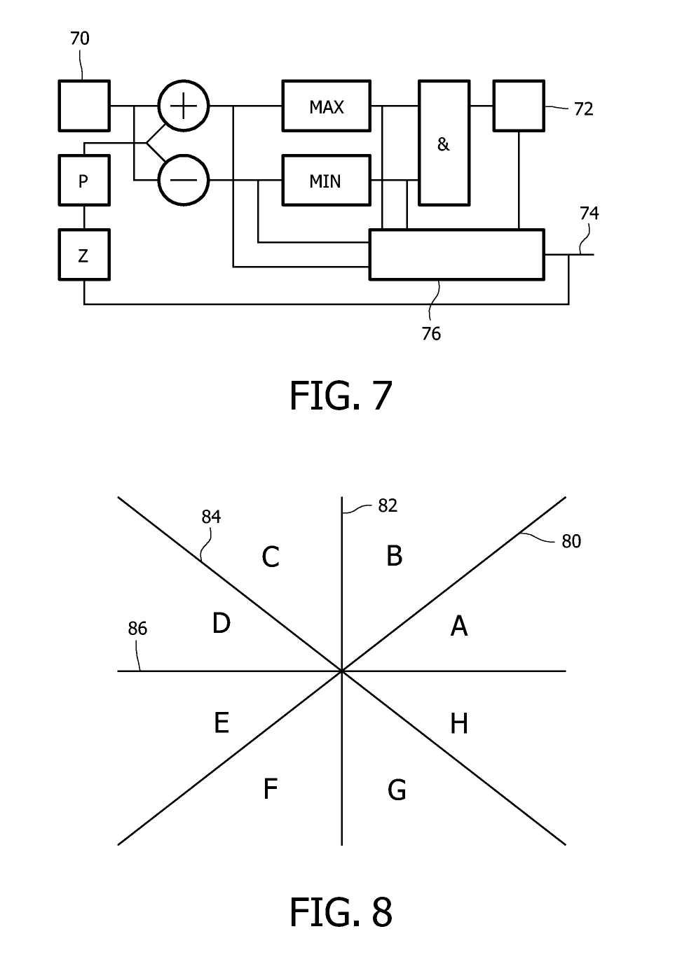

FIG. 7 shows a decompression apparatus;

FIG. 8 shows two-dimensional corrections.

FIG. 1 shows a compression-decompression system. The system comprises a compression apparatus 10 and a decompression apparatus 12 coupled by a channel 14. A number of functional components of compression apparatus are shown schematically (although it should be understood that in practice the associated functions may be executed in combination by the same circuit). Compression apparatus 10 is shown to have an input 100 for receiving a stream of input data samples coupled to a series arrangement a prediction correction calculator 102, a sign filter 104 and an encoder 106. The output of encoder 106 is coupled to decompression apparatus 12 via channel 14. Channel 14 may represent a communication channel, such as a cable connection or a wireless transmission medium or a memory medium or storage device for storing compressed data for later retrieval.

In operation prediction correction calculator 102 computes numbers that represent differences, which will be called “prediction differences”, between actual input sample values and predicted values. The prediction differences can be positive or negative. Sign filter 104 transmits the absolute values of these numbers (i.e. the number itself if it is positive and minus the number if it is negative), optionally followed by the sign of these numbers. Encoder 106 forms codes that represent the absolute values followed by the sign. Sign filter 104 transmits the sign only if sign filter 104 detects that the sign is necessary for decompression apparatus 12 to regenerate the input sample value (or an approximation thereof). To explain when the sign is needed operation of decompression apparatus will first be explained.

FIG. 2 shows a flow-chart of a decompression process. In a first step 21 decompression apparatus 12 accepts an encoded symbol that encodes the absolute value of a prediction difference and retrieves the absolute value A. In a second step 22 decompression apparatus 12 computes a prediction P of a corresponding sample value. In a third step 23 decompression apparatus test whether P+A is a valid sample value. In a simple embodiment this involves testing whether P+A exceeds a maximum valid sample value MAX. If P+A is not a valid sample value decompression apparatus 12 executes a fourth step 24 setting the decompressed output value of decompression D to P−A.

If P+A is a valid sample value decompression apparatus 12 executes a fifth step 25 to test whether P−A is a valid sample value. In a simple embodiment this involves testing whether P−A is below a minimum valid sample value MIN. If P−A is not a valid sample value decompression apparatus 12 executes a sixth step 26 setting the decompressed output value of decompression D to P+A. The minimum and maximum are 0 and 255 for a video signal compression example, or −2¹⁶ and 2¹⁶−1 for an audio compression example.

If P−A is also valid decompression apparatus 12 executes a seventh step 27, to read the sign S from channel 14 and to set D to P+A or P−A, according to the sign, i.e. effectively to P+S*A. It should be noted that the sign bit is read only if both P+A and P−A are valid sample values. If either P+A or P−A is not a valid sample value, no sign bit is read and the next bit from channel 14 is treated as part of the next symbol instead. An additional test may, of course, be added before third step 23 to detect whether the absolute value is zero, in which case D=A and no sign bit needs to be read.

It should be emphasized that the flow-chart of FIG. 2 has been given to show a simple example wherein decompression apparatus uses a predicted value P and a correction value A to determine whether a sign bit has been omitted because one of the possible sign values would lead to an invalid decompression result D.

In practice decompression may involve more complicated techniques. For example although the sign bit preferably immediately follows the symbol that encodes the absolute value in a compressed data stream (or more generally in a sequence of data), this is not necessary. Alternatively, symbols that encode absolute values and corresponding sign bit may be separated from each other or encoded in different parts of such a sequence. In this case decompression apparatus 12 locates the sign bits and determines for each absolute value whether it requires a sign bit, the resulting information about which absolute values need sign bits determining which sign bit belongs to which absolute value. As another example, a combinations of correction values may be subjected to some form of filtering (e.g. low-pass filtering) before the absolute value and sign are determined. Thus, instead of a correction value that always corrects the predicted value towards the input signal value, sometimes other corrections are made. This may be used for noise shaping purposes for example, to reduce the perceptibility of errors due to compression of the correction values.

As another example, in a further embodiment, if compression apparatus 10 quantizes the correction values, decompression apparatus 12 may be arranged to clip a P+A value to MAX if it is above the maximum allowable sample value MAX. Compression apparatus 10 may take account of this type of clipping during quantization of corrections that would lead to P+A values near MAX. If the P+A value is near MAX compression apparatus 10 may use a quantized value A that leads to a P+A value above MAX, in the knowledge that decompression apparatus 12 will clip to MAX. In this embodiment the condition for validity in test third step 23 is preferably replaced by the condition whether P+A is less than MAX′, where MAX′ is higher than MAX. MAX′ is preferably set at least to the maximum P+A value that compression apparatus 10 is able to use after quantization. A higher value of MAX′ is allowed, since this does not lead to ambiguity, but only to unnecessary inclusion of sign information in some cases. MAX′ may be set to MAX plus the maximum possible quantization step for example. If compression apparatus uses rounding to the nearest quantized value, MAX′ may be set to MAX plus the half maximum possible quantization step, or to MAX plus another fraction of the quantization step, so that it is ensured that MAX′ is at least as high as the maximum value P+A that the design of compression apparatus 10 allows after quantization. In a further embodiment MAX′ is set dependent on the predicted value, to the maximum value P+A that the design of compression apparatus allows for the current P value.

Similarly, in this embodiment the condition in fifth step 25 preferably is replaced by a condition whether P−A is higher than MIN′, where MIN′ is lower than MIN in a similar way as MAX′ can be above MAX.

FIG. 3 shows a flow chart of an example of compression in compression apparatus 10. The core of this flow chart comprises the same steps as used in decompression (FIG. 2) to determine whether it is necessary to read a sign bit. These steps have been given the same number as the corresponding steps of FIG. 2. Instead of first step 21 compression comprises a first step 31 of computing A and the sign and a second step of encoding A without the sign. Instead of seventh step 27, compression involves a coding step 33 to add the sign to the compressed data under the circumstances where decompression apparatus 12 will need the sign. Additionally, of course, if decompression apparatus 12 tests for zero valued absolute values, the sign bit may be omitted if the absolute value A is zero.

In the example give above suppression of the sign is preferably used to increase compression by omitting the sign bit in the compressed data. In another embodiment the bandwidth that is saved by omission of the sign bit is used to increase the accuracy with which the absolute values A are represented. In a further embodiment the accuracy of the absolute values is increased selectively for those samples where the sign bit is omitted. This has a better than average effect on overall compression accuracy.

In this further embodiment compression apparatus 10 uses a codeword of a first length to represent the absolute value A in the compressed data when the sign bit is included in the compressed data and as codeword of a second length, equal to the first length plus one when the sign bit is not included. The extra bit is used to increase the resolution of quantization, for example to indicate whether or not an additional correction should be added to the quantized value or not.

FIG. 4 shows an example of quantized values Q and Q′ values as a function of absolute value A. Correction values for which no sign bit is included in the compressed data are quantized according to Q′, with finer gaps between quantized values Q′ than between the quantized values Q that are used for absolute values for which the sign bit is not included in the compressed data. Typically half the gap size is used. Thus, quantization errors will be smaller if no sign is needed. During encoding, a set of symbols is sued to distinguish between different quantized values Q, so that fewer bits are needed to represent Q than would be needed to represent A. The additional bit is used to distinguish between the additional levels provided by Q′.

Typically, a non-uniform gap size between quantized values is used, with increasing gaps between correction values of increasing absolute value. When the absolute correction value is large it is more likely that it will be possible to omit the sign bit. By selectively using finer quantization gaps for those correction values for which the sign bit is omitted, more larger quantization errors will be avoided, while a regular stream a fixed amount of data for each sample is maintained, which facilitates processing of the compressed stream.

It should be emphasized that the actual quantized values in FIG. 4 have been selected merely for the sake of example. In practice the quantized values may be chosen differently, to realize a minimum loss of perceived information content. Advantageously, the figure shows an example where quantization values Q are a subset of Q′, an additional Q′ value being inserted between each pair of Q values. This simplifies switching between different quantizations.

Although in this embodiment the finer quantization is preferably used for all compressed samples for which the sign bit is omitted, it should be realized that alternatively the finer quantization may be used only for part of the samples. Compression apparatus 10 and decompression apparatus 12 may select these samples for example on the basis of their position relative to a reference position in a stream of compressed data, or on the basis of the absolute value A (only absolute value A above a threshold being encoded with an additional bit for example). Thus bandwidth is saved, which may be used for other purposes such as non-differential encoding of sample values at predetermined positions in the stream.

In a further embodiment compression apparatus 10 and decompression apparatus 12 may be arranged to select whether a sign bit is simply omitted or replaced by information to refine quantization on the basis of a compression budget. Compression apparatus 10 and decompression apparatus 12 simply omit the sign bit if the budget is below a threshold, and use replacement otherwise. Compression apparatus 10 and decompression apparatus 12 increase the budget when only omission of the sign bit is used. In a further embodiment compression apparatus 10 and decompression apparatus 12 may use additional techniques to increase the budget, when it is below the threshold, for example by the replacement of small absolute values A by zero values (e.g. only the absolute value one) during compression, so that the sign bit can be omitted more often.

FIG. 5 shows an embodiment of a compression apparatus which comprises a plurality of compression units 50a-c, a multiplexer 52 and a selection unit 54. Selection unit 54 has inputs to receive length information from the compression units 50a-c and an output coupled to a control input of multiplexer 52. Compressed data outputs of compression units 50a-c are coupled to inputs of multiplexer 52. In operation each of compression units 50a-c applies a different compression technique. When the same block of data from the input has been compressed by each of compression units 50a-c, compression units 50a-c signal the length of the resulting compressed data to selection unit 54, which controls multiplexer 52 to pass compressed data that represents the block with the shortest length, in combination with a code that identifies the compression unit 50a-c that has produced the block. Alternatively, selection unit 54 may be arranged to detect whether the block from the compression unit 50a-c that produces best quality is below a threshold and to select the block from another compression unit 50a-c if this is not the case.

In an embodiment part of compression units 50a-c implement the technique of omitting sign bits, and other ones of the compression units 50a-c implement different techniques, using for example a finer quantization and a variable length coding technique. In a further embodiment one of compression units 50a-c may use a technique with a first quantization accuracy and omission of sign bits without replacement of those sign bits with other information, while another one of compression units 50a-c may use a technique with a second, coarser quantization accuracy and replacement of omitted of sign bits with bits that decrease the quantization steps for samples wherein the sign bit is omitted. Thus different compression techniques may be used to provide compressed data for different blocks.

Both compression apparatus 10 and decompression apparatus 12 may be implemented using suitably programmed instruction processor, wherein the programs implement flow-charts that contain element similar to those of FIGS. 2 and 3. A digital signal processor may be used for example, or a VLIW processor, which comprise a plurality of functional elements for execution of different instructions in parallel. Such parallel execution makes it possible to execute different operations involved in compression in parallel in pipe-lined fashion. Alternatively circuits may be used that are configured respective ones of these pipelining steps.

FIG. 6 shows a functional diagram of a device for compression. The device has an input 60 for receiving successive samples and output queues 62, 64 for absolute values and signs respectively. A subtractor 66 subtracts a prediction value from an input sample from input 60. An absolute value/sign unit SA converts the difference from subtractor 66 into a sign and an absolute value. The absolute value is quantized by a quantizer Q which outputs the quantized result to the absolute value output queue 62. The quantized value is also supplied to an adder and a subtractor to add and subtract the quantized value to and from the prediction value respectively. A sum and difference are supplied to validity testers MAX and MIN, which are output to an AND unit. If both validity testers MAX and MIN indicate valid values AND unit controls sign output queue to accept the sign value. A delay element Z supplies a previous sign and quantized absolute value to a predictor P that uses this data to form the prediction value.

It should be appreciated that the diagram is a functional diagram that can be implemented by many different circuit. In one embodiment each element of the figure is implemented by a corresponding circuit. Quantizer Q may be implemented using a lookup table memory for example. In an alternative embodiment one ore more of the elements are implemented using a programmable processor and an instruction or instructions to make that programmable processor perform the function of the element. Although a single delay element Z has been shown, it should be appreciated that a circuit for implementing the diagram may contain more delay elements to perform pipelined processing, or to store data between execution of successive instructions. Output queues 62, 64 may be combined Typically these are coupled to a channel encoder and/or a modem for transmitting compressed data over a medium, or to store the compressed data in a storage device not shown.

FIG. 7 shows a functional diagram of a device for decompression. It comprises an absolute value input queue 70 and a sign input queue 72 and further elements similar to those of FIG. 6 and indicated by similar symbols. Absolute value input queue 70 is coupled to an adder and a subtractor to add and subtract the quantized value to and from a prediction value respectively. A resulting sum and difference are supplied to validity testers MAX and MIN, which are output to an AND unit. The AND unit controls whether sign input queue 72 will advance. The resulting sum and difference are also supplied to a multiplexer 76, which is controlled by the outputs of the validity testers MAX and MIN and a sign from sign input queue 72. Multiplexer 76 has an output 74 for outputting decompressed data. Multiplexer 76 outputs the sum of the prediction value and the absolute value if the prediction value minus the absolute value is invalid. Multiplexer 76 outputs the prediction value minus the absolute value if the prediction value plus the absolute value is invalid. If both are valid the sign from sign input queue 72 multiplexer 76 outputs the prediction value plus or minus the absolute value under control of the sign from sign input queue 72. A delay element Z supplies a previously decoded decompressed value to a predictor P that uses this data to form the prediction value.

It should be appreciated that this diagram too is a functional diagram that can be implemented by many different circuit. Input queues 70, 72 may be combined. Typically these queues are coupled to a channel decoder and/or a modem for receiving compressed data from a medium, or to retrieve the compressed data form a storage device (not shown). In one embodiment each element of the figure is implemented by a corresponding circuit. In an alternative embodiment one ore more of the elements are implemented using a programmable processor and an instruction or instructions to make that programmable processor perform the function of the element. Although a single delay element Z has been shown, it should be appreciated that a circuit for implementing the diagram may contain more delay elements to perform pipelined processing, or to store data between execution of successive instructions.

Although the invention has been described for the omission of sign bits in compressed data it should be appreciated that a similar technique could be used to omit other information. For example a decompression apparatus may be arranged to receive a least significant part U₁ of a correction value and to make reading of a most significant part U₂ conditional on the result of a test whether more than one value of the most significant part can lead to a valid signal value when the most and least significant part are added to the prediction P. In this case, the compression apparatus may be arranged to compute the correction U from the difference between a sample value S and its prediction P and to omit the most significant part U₂ of the correction U from the compressed data if the least significant part U₁ leaves no more than one value of the least significant part that leads to a valid result. This example could be combined with conditional omission of the sign bit, for example by including both the sign bit of the correction and the most significant part of the absolute value in the compressed data only under certain conditions.

In another example the role of the least and most significant part may be interchanged, the least significant part being included conditionally, but this will generally offer only limited gain, since the least significant part can typically be omitted only for samples values very close to the edge of the range of valid sample values.

As another example, the technique may be applied to vector valued samples, such as samples that represent color as vectors of YUV or RGB data, or groups of successive sample values. In this case, sample vectors may be encoded as absolute values and a direction code to indicate one of eight quadrants. The direction code, or part thereof, for a sample is conditionally omitted from the compressed data (e.g. a part that selects a hemisphere or from a number of quadrants is omitted). The direction code is omitted partly or entirely if there is only one valid sample vector among the possible sample vectors that can be encoded by different values of the direction code or the omitted part of the direction code. This technique could be said to subdivide the range of possible corrections in cones that correspond to octants. Alternatively, an encoding could be used that subdivides the range of possible corrections into cones of another shape (e.g. diagonally halved octants), and uses compressed data that selects a cone and a position in the cone. In this case part or whole of the compressed data the selects the cone may be omitted conditionally. It should be clear that conditional omission could be applied other encoding techniques as well.

FIG. 8 illustrates this for the case of two-dimensional corrections, with a plane divided into quadrants by lines 80, 82 and quadrants halved by diagonal lines 84, 86. Here a sector code may be used to indicate in which of eight sectors A-H a correction A lies, in combination with information to indicate the position of the correction in a sector (position codes indicating positions that are mirror images of one another in sectors A and B, and rotated images of those positions in other sectors C-H). Compression apparatus 10 may omit the sector code, or part of the sector code if the correction if this does not lead to more than one valid signal value. In an alternative embodiment the sector code could indicate one of four quadrants AB, CD, EF, GH and be omitted if this leads to no more than one valid signal value. In yet another embodiment a two-part sector code may be used, one part indicating a hemisphere (A-D or E-H) and the other a quadrant within a hemisphere. In yet another embodiment a two or three-part sector code may be used, a further part indicating half quadrant within a quadrant. In any of these embodiments selected parts of the sector code may be omitted if this does not lead to more than one valid result.

Any kind of prediction may be used. A very simple form of prediction is to the use a sequential stream of samples and to use the decompressed value of the previous sample in the stream as the prediction P. More advanced techniques may involve extrapolation from a plurality of decompressed values of a plurality of previous samples in the stream. As an alternative interpolation may be used, between decompressed sample for surrounding positions in the stream. In the case of image compression two-dimensional interpolation or extrapolation may be used and/or interpolation or extrapolation between different images in a video sequence.

Although the invention has been described using embodiments wherein the correction is arithmetically added to the prediction value to obtain a decompressed value, it should be understood that other forms of combining the correction and the prediction value may be used. For example, the correction and the prediction value may be subtracted instead, or used in a factor by which the prediction value is multiplied (e.g. P*(1+S*A)) or divided (P/(1+S*A). In general the term “adding” a correction value is used herein for any such form of combination of the correction and the prediction value.

Although the invention has been described for an embodiment wherein valid sample values are defined by a range between a MIN and a MAX value, it should be appreciated that different definitions of validity may be used. For example, in one embodiment only sparse sample values may be defined as valid. In this case the tests to determine whether a sign bit is needed involve determining whether the P+A and P−A lead both to valid values. When vector values samples are used the range of valid sample values may be defined by a sphere, a cube or other type of polygon in vector space.

1. A signal compression apparatus for generating compressed data for a decompression process that forms a decompressed data value by adding a correction to a signal value prediction that is obtained from the compressed data, the apparatus comprising:
an input for receiving an input value;
a computing circuit arranged to compute a correction value needed to correct the signal value prediction, to compute a first part of correction information that represents the correction value, and to test whether more than one valid possible decompressed data value can be obtained by adding the signal value prediction to all of a plurality of different possible correction values that are consistent with the first part; and
a compressed data collector arranged to include the first part in the compressed data and to include a second part of the correction information in the compressed data, for selecting among the more than one possible decompressed data values, conditional on a result of said testing, if there is more than one valid possible decompressed data value, the compressed data collector being arranged to include further information into space for said second part in said compressed data, in cases where there is no more than one valid possible decompressed data value;
wherein the computation circuit is arranged to compute said further information as a refinement to increase an accuracy of the correction value.

2. The signal compression apparatus according to claim 1, wherein the computation circuit is arranged to compute the first part so that different possible correction values that are consistent with a same value of the first part have substantially the same absolute value.

3. The signal compression apparatus according to claim 2, wherein said first part represents an absolute value of the correction and said second part represents a sign of the correction.

4. The signal compression apparatus according to claim 1, wherein the computation circuit comprises a quantizer arranged to quantize the correction values to form the first part using non-uniform quantization.

5. The signal compression apparatus according to claim 1, wherein the compressed data collector comprises a variable length encoder arranged to encode the first part.

6. (canceled)

7. The signal compression apparatus according to claim 1, wherein the computation circuit is arranged to perform said test by comparing whether no more than one of the possible decompressed data values lies between a minimum and maximum value.

8. The signal compression apparatus according to claim 7, further arranged to handle input values between further minimum and maximum for valid ones of the input values, wherein the minimum and maximum value lie at a distance below and above the further minimum and maximum respectively.

9. The signal compression apparatus according to claim 1, further comprising a plurality of compression units, a first one of the compression units including the computation circuit, and further comprising a selection unit coupled to the compression units to select for respective blocks of input data from which of the compression units corresponding compressed blocks will be used for inclusion in the compressed data.

10. A signal decompression apparatus, wherein a decompressed data value is formed by adding a correction value to a signal value prediction, the decompression apparatus comprising:
a source circuit for providing compressed data; and
a computing circuit arranged to compute the signal value prediction from the compressed data, to read a first part of correction information from the source circuits, to test whether more than one valid possible decompressed data value can be obtained by adding the signal value prediction to all of a plurality of different possible correction values that are consistent with the extracted first part, to output the only valid decompressed data value if there is no more than one valid possible decompressed data value, and, if there is more than one valid possible decompressed data value, to read a second part of the correction information from the source circuit and to compute the decompressed data value according to said first and second part, wherein the source circuit is arranged to provide further information from space for said second part in said compressed in cases where there is no more than one valid possible decompressed data value;
wherein the computation circuit is arranged to use said further information from said space to refine an accuracy of the first part when there is no more than one valid possible decompressed data value.

11. The signal decompression apparatus according to claim 10, wherein the computing circuit is arranged to use said first part as a representation of an absolute value of the correction and said second part as a sign of the correction.

12. (canceled)

13. The signal decompression apparatus according to claim 10, wherein said testing involves testing whether no more than one of the possible decompressed data values lies between a minimum and maximum value.

14. The signal decompression apparatus according to claim 10, comprising clipping the decompressed data values to within a sub-range of a range between the minimum and maximum value.

15. The signal decompression apparatus according to claim 10, comprising an image signal output for controlling image display on a display screen, the decompressed data controlling at least part of a pixel intensity of the image.

16. A method of compressing a signal for use in a decompression process wherein a decompressed data value is formed by adding a correction to a signal value prediction obtained from the compressed data, the method comprising:
reading an input value of a signal;
computing the correction value needed to correct the signal value prediction;
computing a first part of correction information that represents the correction value;
testing whether more than one valid possible decompressed data value can be obtained by adding the signal value prediction to all of a plurality of different possible correction values that are consistent with a first part;
including a second part of the correction information in the compressed data conditional on said testing, if there is more than one valid possible decompressed data value; and
inserting further information into space for said second part in said compressed data, in cases where there is no more than one valid possible decompressed data value, wherein said further information represents a refinement of the correction value.

17. The method of compressing a signal according to claim 16, wherein the first part is computed so that different possible correction values that are consistent with a same value of the first part have substantially the same probability of occurrence.

18. The method of compressing a signal according to claim 16, wherein said first part is computed so that different possible correction values that are consistent with a same value of the first part have substantially the same absolute value.

19. The method of compressing a signal according to claim 18, wherein said first part represents an absolute value of the correction and said second part represents a sign of the correction.

20. The method of compressing a signal according to claim 16, wherein the correction values are encoded in the first part using non-uniform quantization.

21. The method of compressing a signal according to claim 16, wherein the correction values are encoded in the first part using variable length encoding.

22. (canceled)

23. The method of compressing a signal according to claim 16, wherein said testing involves testing whether no more than one of the possible decompressed data values lies between a minimum and maximum value.

24. The method of compressing a signal according to claim 23, the minimum and maximum value lie a quantization distance or a fraction thereof below and above a further minimum and maximum for valid ones of the input values.

25. The method of compressing a signal according to claim 16, wherein the input value is obtained from an input image.

26. A method of decompressing data wherein a decompressed data value is formed by adding a correction value to a signal value prediction, the method comprising:
computing the signal value prediction from compressed data;
reading a first part of correction information from the compressed data;
testing whether more than one valid possible decompressed data value can be obtained by adding the signal value prediction to all of a plurality of different possible correction values that are consistent with the extracted first part;
reading a second part of the correction information from the compressed data conditional on a result of said testing, if there is more than one valid possible decompressed data value, and
computing the decompressed data value according to said first and second part;
outputting the only valid decompressed data value if there is no more than one valid possible decompressed data value; and
using further information from space for said second part in said compressed data in cases where there is no more than one valid possible decompressed data value, said information from said space being used to increase an accuracy of the first part when there is no more than one valid possible decompressed data value.

27. The method of decompressing compressed data according to claim 26, wherein said first part is used as an absolute value of the correction and said second part as a sign of the correction.

28. (canceled)

29. The method of decompressing compressed data according to claim 26, wherein said testing involves testing whether no more than one of the possible decompressed data values lies between a minimum and maximum value.

30. The method of decompressing compressed data according to claim 29, comprising clipping the decompressed data values to within a sub-range of a range between the minimum and maximum value.

31. The method of decompressing compressed data according to claim 26, wherein the compressed data represents a compressed image signal, the method comprising using the decompressed data to control display of an image.

32. (canceled)

33. (canceled)

34. (canceled)
